(19) United States
(12) Patent Application Publication
(10) Pub. No.: US 2024/0427821 A1
(43) Pub. Date: Dec. 26, 2024

(54) DATA PROCESSING METHOD, CATEGORY IDENTIFICATION METHOD AND COMPUTER DEVICE

(71) Applicant: MaShang Consumer Finance Co., Ltd., Chongqing (CN)

(72) Inventors: Hongyu ZHAO, Chongqing (CN); Guoqing ZHAO, Chongqing (CN); Ning JIANG, Chongqing (CN); Bing XIAO, Chongqing (CN)

(21) Appl. No.: 18/824,490

(22) Filed: Sep. 4, 2024

Related U.S. Application Data
(63) Continuation of application No. PCT/CN2023/132685, filed on Nov. 20, 2023.

(30) Foreign Application Priority Data
Dec. 8, 2022 (CN) 202211570272.6

(51) Int. Cl. G06F 16/906; G06F 16/901

(52) U.S. Cl. CPC G06F 16/906; G06F 16/9024

(57) ABSTRACT

The present application provides a data processing method, a category identification method and a computer device, in which, firstly, node information is screened out based on node edge data and feature information, that is, K first nodes with rich structures and high feature discrimination are located, and then a feature similarity is calculated based on relevant information of the first nodes. On the other hand, since a calculation amount of the feature similarity of the node is relatively small, for a case that model training and prediction of node category are completed at the same time, a second node can include a node to be classified, and a model parameter used in category prediction is obtained by performing parameter iterative updating with taking the node to be classified as an unlabeled node.

### CROSS-REFERENCE TO RELATED APPLICATIONS

The present application is a continuation of International Application No. PCT/CN2023/132685, filed on Nov. 20, 2023, which claims priority to Chinese patent application No. 202211570272.6, entitled “DATA PROCESSING METHOD, CATEGORY IDENTIFICATION METHOD AND COMPUTER DEVICE” and filed on Dec. 8, 2022. The two applications are hereby incorporated by reference in their entireties.

### TECHNICAL FIELD

The present application relates to the technical field of computers and, in particular, to a data processing method, a category identification method and a computer device.

### BACKGROUND

With the continuous development of artificial intelligence technology, as graph data has more structural data, it will be more helpful to model parameter learning if the graph data is used as input data of the model, thus, graph neural network model comes into being. In some cases, the graph neural network model can be used as a classification model to predict a category of an unlabeled node in the graph data, for example, the graph data includes a labeled node of a known category and an unlabeled nodes of an unknown category, and graph neural network model can be used to predict the category of the unlabeled node in the graph data. For example, the unlabeled node includes an article node, and the category of an article to be classified is identified by using the graph neural network model. For another example, the unlabeled node includes a user node, and the graph neural network model is used to identify whether a user is a risky user or identify whether the user is a potential user of a product to be pushed.

However, in the training process of the graph neural network model, considering the introduction of the attention mechanism, it is usually necessary to calculate a feature similarity between two adjacent nodes, and then take the feature similarity as a weight coefficient, aggregate feature of another second node based on feature information of a second node and a corresponding weight coefficient. That is, different weight values are assigned to different neighborhood nodes according to the feature similarity between a neighborhood node and a second node, and then a node category is predicted based on the aggregated feature information. As all nodes in the graph data need to be traversed, the feature similarity between two nodes with a connection edge needs to be calculated one by one. Therefore, in some cases, a calculation amount of the feature similarity between target objects (such as articles, users, etc.) represented by the second node in the training process of a classification model (such as the graph neural network model) is relatively large, which leads to a time-consuming training of the classification model for identifying a category of the target object (such as identifying an article category, identifying a category, and so on).

### SUMMARY

The purpose of the present application is to provide a data processing method and a category identification method, so as to improve a prediction accuracy of a category of an object to be classified (such as an article category, a user category, etc.).

In order to realize the above technical scheme, the embodiments of the present application is realized as follows.

On an aspect, the present application provides a data processing method, the method includes: determining node information of a first node based on edge data and feature information of a second node of graph data; where the second node includes a labeled node and the first node; calculating feature similarity between the second node and a neighborhood node of the second node based on the node information of the first node; aggregating feature information of the second node based on the feature similarity and feature information of the neighborhood node; determining a prediction result based on the aggregated feature information, where the prediction result includes a predicted category label of the labeled node; and iteratively updating a parameter of a classification model based on the predicted category label of the labeled node and a real category label of the labeled node.

On an aspect, the present application provides a category identification method, the method includes: determining node information of a first node based on graph data, where the graph data includes a node to be classified and a sampled node, and the node to be classified and the sampled node include the first node; calculating feature similarity between the node to be classified and a neighborhood node of the node to be classified based on the node information of the first node, aggregating feature information of the node to be classified based on the feature similarity and feature information of the neighborhood node; and determining predicted category information of the node to be classified based on the aggregated feature information.

On an aspect, the present application provides a data processing apparatus, the apparatus is provided with a classification model including a node screening layer, a feature aggregation layer and a category prediction layer, where the node screening layer, configured to determine node information of a first node based on edge data and feature information of a second node of graph data; where the second node includes a labeled node and the first node; the feature aggregation layer, configured to calculate a feature similarity between the second node and a neighborhood node of the second node based on the node information of the first node; aggregate feature information of the second node based on the feature similarity and feature information of the neighborhood node; the category prediction layer, configured to determine a prediction result based on the aggregated feature information, where the prediction result includes a predicted category label of the labeled node; and iteratively update a parameter of a classification model based on the predicted category label of the labeled node and a real category label of the labeled node.

On an aspect, the present application provides a category identification apparatus, the apparatus is provided with a classification model including a node screening layer, a feature aggregation layer and a category prediction layer, the apparatus includes: the node screening layer, configured to determine node information of a first node based on graph data, where the graph data includes a node to be classified and a sampled node, and the node to be classified and the sampled node include the first node; the feature aggregation layer, configured to calculate a feature similarity between the node to be classified and a neighborhood node of the node to be classified based on the node information of the first node, aggregate feature information of the node to be classified based on the feature similarity and feature information of the neighborhood node; and the category prediction layer, configured to determine predicted category information of the node to be classified based on the aggregated feature information.

On an aspect, the present application provides a computer device, including: a processor; and a memory arranged to store computer-executable instructions, the computer-executable instructions is configured to be executed by the processor, so as to cause the processor to perform the above method.

On an aspect, the present application provides a storage medium for storing computer-executable instructions which cause a computer to perform the steps of the above method.

On an aspect, the present application provides a computer program product including a non-transitory computer-readable storage medium storing a computer program operable to cause a computer to perform the above method.

### BRIEF DESCRIPTION OF DRAWINGS

In order to explain the technical scheme of the embodiments of the present application more clearly, the drawings needed in the embodiments will be briefly introduced below. Obviously, the drawings in the following description are one or more embodiments recorded in the present applications. For those skilled in the art, other drawings can be obtained according to these drawings without paying creative effort.

FIG. 1 is a first flow diagram of a data processing method provided by an embodiment of the present application.

FIG. 2A is a second flow diagram of a data processing method provided by an embodiment of the present application.

FIG. 2B is a flow diagram of each model training process in a data processing method provided by an embodiment of the present application.

FIG. 3 is a first implementation schematic diagram of a data processing method provided by an embodiment of the present application.

FIG. 4 is a second implementation schematic diagram of a data processing method provided by an embodiment of the present application.

FIG. 5 is a third implementation schematic diagram of a data processing method provided by an embodiment of the present application.

FIG. 6 is a fourth implementation schematic diagram of a data processing method provided by an embodiment of the present application.

FIG. 7A is a first flow diagram of a category identification method provided by an embodiment of the present application.

FIG. 7B is a second flow diagram of a category identification method provided by an embodiment of the present application.

FIG. 8 is a schematic diagram of a module composition of a data processing apparatus provided by an embodiment of the present application.

FIG. 9 is a schematic diagram of module composition of a category identification apparatus provided by an embodiment of the present application.

FIG. 10 is a schematic structural diagram of a computer device provided by an embodiment of the present application.

### DESCRIPTION OF EMBODIMENTS

In order to make people in the technical field better understand the one or more technical solutions of the applications, the technical solutions in the embodiments of the present application will be described clearly and completely with reference to the accompanying drawings. Obviously, the described embodiments are only part of one or more embodiments of the present application, but not all of them. Based on one or more embodiments in the present application, all other embodiments obtained by those skilled in the art without creative effort should belong to the protection scope of the present application.

It should be noted that, under the condition of no conflict, one or more embodiments in the present application and the features in the embodiments can be combined with each other. Embodiments of the present application will be described in detail with reference to the accompany drawings and in combination with the embodiments.

One or more embodiments of the present application provide a data processing method and a category identification method. In order to improve category prediction accuracy of a classification model (such as a graph neural network model), the number of nodes in graph data is usually increased, which will increase the calculation amount of feature similarity of the nodes. Therefore, in order to reduce the calculation amount of the feature similarity of the nodes, if random sampling is adopted for a neighborhood node of a certain second node, only the feature similarity between the second node and the randomly sampled neighborhood node is calculated, and then features of the randomly sampled neighborhood node is aggregated to the second node based on different weight coefficients, which will inevitably lead to the problem of low accuracy of the randomly sampled neighborhood node. For example, if a first neighborhood node of the second node (such as a neighborhood node with rich structural information and high discrimination of feature information) is filtered out, the accuracy of feature aggregation of the second node will be low, which will lead to the low accuracy of the predicted category label of the second node, and then lead to low accuracy of iterative updating of a model parameter. Based on the above problems, this technical scheme relies on long tail distribution characteristics of a self-attention mechanism, that is, the self-attention mechanism is sparse, and less dot products contribute most of the attention scores, while the rest dot products can be omitted, that is, some neighborhood nodes with greater contribution to a central node can be used as the first neighborhood node, while the rest second neighborhood node with smaller contribution to the central node can be omitted. Therefore, firstly, node information is screened out based on node edge data the and node feature information, that is, K first nodes with rich structure and high feature discrimination are located, and then the feature similarity is calculated based on relevant information of the first node, so that a fourth node will not participate in the calculation of the feature similarity as the first neighborhood node of the central node (that is, any second node), so that sparse processing is performed on the neighborhood node of the central node, thus reducing the calculation amount of the feature similarity of the nodes (that is, the calculation amount of the attention scores of the central node and some neighborhood nodes is omitted), and improving training efficiency of the model. On the other hand, as the calculation amount of the feature similarity of the nodes can be accurately controlled to be relatively small in the model training stage, for a situation that the classification model training and prediction of node category are completed at the same time, that is, the second node can include a node to be classified, the category prediction efficiency of the node to be classified can still be ensured. Moreover, as the model parameter used in the category prediction is obtained through iteratively updating a parameter by taking the node to be classified as an unlabeled node, the accuracy of the model parameter can be improved, and the effect of considering both category prediction efficiency and prediction accuracy can be achieved.

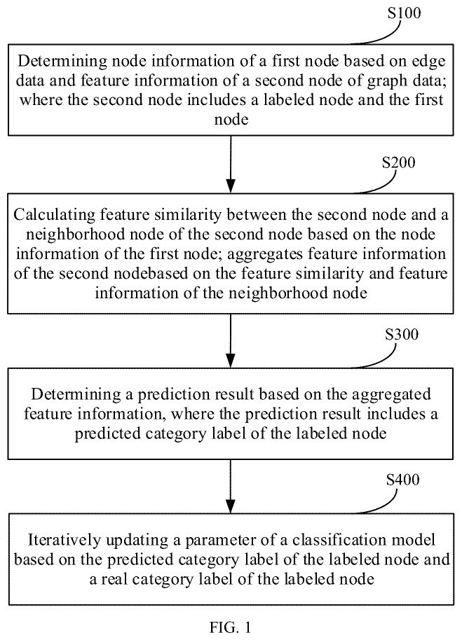

FIG. 1 is a first flow diagram of a data processing method provided by one or more embodiments of the present application. The method in FIG. 1 can be executed by an electronic device provided with a training apparatus for a classification model, the electronic device can be a terminal device or a designated server. The classification model can be applied to any application scenario that needs to classify a node in the graph data, for example, to predict a category of an article node to be tested in the graph data, for another example, to predict a category of a user node to be identified in the graph data (for example, identifying whether the user applying for loan business is a risky user, or identifying whether a registered user of the preset application is a pushed user of a target commodity, etc.). As shown in FIG. 1, the above data processing method at least includes the following steps.

S100, determining node information of a first node based on edge data and feature information of a second node of graph data; where the second node includes a labeled node and the first node.

The graph data may include first graph data corresponding to a classification task, and the first graph data may include second nodes, feature information of the second nodes, and edge data between the second nodes.

S200, calculating feature similarity between the second node and a neighborhood node of the second node based on the node information of the first node; aggregates feature information of the second nodebased on the feature similarity and feature information of the neighborhood node.

The neighborhood node can be a neighborhood node of the second node among first nodes, that is, the neighborhood node of the second node refers to a first node with a connection edge with the second node among a plurality of screened first nodes, and can also be referred as a first neighborhood node of the second node.

S300, determining a prediction result based on the aggregated feature information, where the prediction result includes a predicted category label of the labeled node. S400, iteratively updating a parameter of a classification model based on the predicted category label of the labeled node and a real category label of the labeled node.

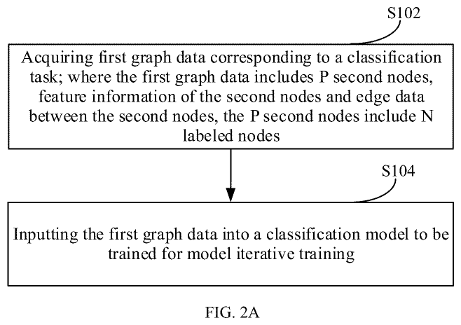

In some example embodiments, taking the graph data including a first graph data corresponding to the classification task as an example, as shown in FIG. 2A, the data processing method at least includes the following steps.

S102, acquiring first graph data corresponding to a classification task; where the first graph data includes P second nodes, feature information of the second nodes and edge data between the second nodes, the P second nodes include N labeled nodes, and both P and N are integers greater than 1 and N is less than P.

The classification task can include any one of a task for classifying articles, a task for classifying risky users and a task for classifying pushed users. Correspondingly, the second node is used to represent a target object, and the target object includes any one of an article and a user, and the feature information of the second node includes feature information of the target object represented by the second node. For example, the feature information of the user can include any one of basic feature information and business-related feature information, the basic feature information can include any one of user's age, user's gender and user's occupation, and the business-related feature information can include relevant feature information generated in response to the user's business request for a target business, target business includes online shopping business or loan business. If the target business is loan business, the business-related feature information can include loan amount, loan manner, loan volume, etc. If the target business is to display shopping business, the business-related feature information can include user payment frequency, user payment amount and user receiving address, etc. For another example, the feature information of the article can include any one of keywords, quoted articles and article authors.

The edge data between the second nodes includes a connection edge between the target objects represented by the second nodes (that is, the target objects have a preset association relationship). Taking the target object being the user as an example, if device numbers used by a user A and a user B when initiating a service application are the same, it is considered that the users have a preset association relationship. If a reserved mobile phone number for credit investigation of the user A is the same as a mobile phone number of a contact person of the user B when applying for a business, it is considered that there is a preset association between the users. If an application mobile phone number filled in by the user A when applying for the business is the same as the mobile phone number of the contact person of the user B when applying for the business, it is considered that there is a preset association between the users. If a bound mobile phone number of a bank card of the user A is the same as the mobile phone number of the contact person of the user B when applying for the business, it is considered that there is a preset association between the users.

The labeled node is used to represent a target object with a category label. As for the naming of the second node in the graph data, from the perspective of model usage stage (model training or category prediction), the second node can be a sampled node or a node to be classified. From the perspective of whether a node has a category label, the second node can be a labeled node or an unlabeled node. Usually, the labeled node is used as a sampled node to participate in calculation of a model loss value, and the unlabeled node can be a sampled node to participate in feature aggregation process, and the unlabeled sample can also be a node to be classified. In addition, for the feature aggregation process, the second node can be taken as a central node or a neighborhood node (that is, updating the feature information of a central node based on the feature information of the neighborhood node). From the perspective of the importance of the node itself, the second node can be divided into a first node or a fourth node, and from the perspective of the importance of the neighborhood node to the central node, the neighborhood node can be divided into a first neighborhood node and a second neighborhood node. The naming method of the node can be adjusted according to the actual needs, and does not limit the protection scope of the present application.

The above N is less than or equal to P, and if N can be equal to P, all P second nodes are labeled nodes. However, in order to ensure feature aggregation effect of nodes under the condition that a large number of labeled nodes are not needed, a plurality of unlabeled nodes are usually added to the graph data, that is, P second nodes include not only labeled nodes, but also unlabeled nodes, and N is less than P, so that feature aggregation can be performed on the labeled nodes based on the feature information of the unlabeled nodes, thereby enhancing the feature representation of the labeled nodes, so as to improve the accuracy of category prediction based on the aggregated node feature.

S104, inputting the first graph data into a classification model to be trained for model iterative training.

The classification model can be a graph neural network model (such as a graph attention network model), and the model parameters are iteratively updated based on the first graph data until the training result of the current model meets a preset model training end condition. The above-mentioned preset model training end condition may include that: the number of training rounds of the current model is equal to the total number of training rounds, or a model loss function converges.

In view of the model iterative training process in the above step S104, the specific implementation process of the model iterative training is described below. As the processing process of each model training in the model iterative training process is the same, any model training is taken as an example for detailed explanation. As shown in FIG. 2B, the specific implementation of each model training can include the following steps S1042 to S1048.

S1042, determining first node information based on edge data and feature information corresponding to first graph data; where the first node information corresponds to K first nodes selected from P second nodes; K is an integer greater than 1 and less than P.

From two dimensions of structural information richness and feature information discrimination of second nodes, the K first nodes are screened from the P second nodes, and then the first node information is determined based on relevant information of the K first nodes (such as second score or node feature information), that is, the above-mentioned first node information can include any one of node feature information and second score. In some example embodiments, it can first perform feature importance appraisal based on the feature information, and then perform structural importance appraisal based on the edge data, so as to screen out the K first nodes. In some example embodiments, it can also first perform structural importance appraisal based on the edge data, and then perform feature importance appraisal based on the feature information, so as to screen the K first nodes. In some example embodiments, it can also perform feature importance appraisal based on the feature information, screen K1 third nodes from the P second nodes, and perform structural importance appraisal based on the structural information, and screen K2 third nodes from P second nodes, and then carry out node deduplication processing on the K1 third nodes and the K2 third nodes to obtain the K first nodes.

S1044, calculating feature similarity between a second node and a neighborhood node of the second node among the K first nodes based on the first node information; aggregating feature information of the second node based on the feature similarity and feature information of the corresponding neighborhood node; where the neighborhood node of the second node among the K first nodes refers to a first node with a connection edge with the second node among the K first nodes, that is, a first node with a preset association relationship with the second node among the K first nodes, that is, a first neighborhood node of the second node.

After determining the first node information, any second node is taken as a central node and the feature similarity between the central node and the first neighborhood node (that is, a neighborhood node of the central node among the K first nodes) is calculated, and then the feature similarity is taken as a weight coefficient, and the feature information of the central node is updated based on the feature information of the first neighborhood node. Among them, as the first neighborhood node of the central node is not all neighborhood nodes, but some neighborhood nodes belong to the K first nodes, thus, the calculation amount can be reduced to the calculation amount of the second node and the first neighborhood node, and the calculation amount of the second node and a second neighborhood node (that is, a neighborhood node of the second node among (P−K) fourth nodes) can be omitted.

In the process of feature aggregation, the (P−K) fourth nodes may or may not participate in the feature aggregation. For a case that the (P−K) fourth nodes participate in the feature aggregation, a weight coefficient between the central node and second neighborhood node can be set to a target value (such as a preset value or a minimum value among the weight coefficients corresponding to the first neighborhood nodes). Correspondingly, based on the feature similarity and feature information corresponding to the first neighborhood node as well as the weight coefficient and feature corresponding to the second neighborhood node, the feature aggregation is performed on the second node to obtain the aggregated feature information of the second node.

S1046, determining a prediction result based on the aggregated feature information; where the prediction result includes a predicted category label of N labeled nodes. After the feature of each second node is updated, the aggregated feature information is taken as final feature information of the second node, and then the category prediction is performed on the second node based on the final feature information of the second node to obtain a corresponding predicted category label of each second node.

S1048, iteratively updating a parameter of the classification model to be trained based on the predicted category label of the N labeled nodes and a real category label of the labeled node.

For each labeled node, a loss value is calculated based on the predicted category label and the real category label of the labeled node, and then a total loss value is determined based on the corresponding loss values of the N labeled nodes. Then, the model parameter is updated based on the total loss value. It should be noted that the iterative training of the model parameter based on the total loss value of the model to be trained can refer to the existing process of adjusting and optimizing a model parameter by using gradient descent method back propagation, which is not repeated here.

In the embodiment of the present application, firstly, node information is screened out based on node edge data and node feature information, that is, K first nodes with rich structure and high feature discrimination are located, and then the feature similarity is calculated based on relevant information of the first node, so that a fourth node will not participate in the calculation of the feature similarity as the first neighborhood node of the central node (that is, any second node), so that sparse processing is performed on the neighborhood node of the central node, thus reducing the calculation amount of the feature similarity of the nodes (that is, the calculation amount of the attention scores of the central node and some neighborhood nodes is omitted), and improving training efficiency of the model. On the other hand, in the model training stage, the K first nodes are screened based on the node edge data and the node feature information, instead of being randomly selected from P second nodes. In this way, it can not only reduce the calculation amount of feature similarity, but also accurately determine that the feature similarity between which nodes (that is, a feature similarity between a target object represented by any second node and a target object represented by its first neighborhood node) need to be calculated, while the feature similarity between other nodes (such as a feature similarity between a target object represented by any second node and a target object represented by its second neighborhood node) is omitted. Therefore, in the case that the classification model training and the object category prediction are completed together, that is, the second node can include the node to be classified, and the category prediction efficiency of the node to be classified (that is, the prediction efficiency of the category of object to be classified represented by the node to be classified) can also be ensured. Further, as the model parameter used in category prediction is obtained through iteratively updating a parameter by taking the node to be classified used to represent the object to be classified as an unlabeled node, the feature information and edge data of the object to be classified affect the updating of the model parameter of the classification model, therefore, the accuracy of the category prediction on the object to be classified by using this classification model is higher, and the effect of considering both category prediction efficiency and prediction accuracy of the object to be classified is achieved.

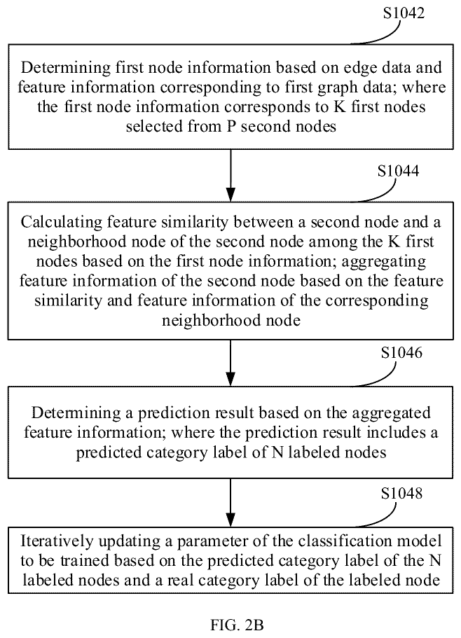

Taking the classification task being a task for identifying risky users as an example, the above classification model is a graph neural network model, and the graph neural network model includes a node screening layer, a feature aggregation layer and a category prediction layer. As shown in FIG. 3, the specific implementation process of the training method of the graph neural network model is illustrated and specifically includes the following steps.

Target graph data (namely the above first graph data) corresponding to the task for identifying risky users is acquired; where the target graph data includes P second nodes, feature information of the P second nodes and edge data between the P second nodes, the P second nodes include N labeled nodes, and both P and N are integers greater than 1 and N is less than P. Specifically, the edge data includes a connection edge between the P second nodes with a preset association relationship, and the preset association relationship may include any one of the following: device numbers used by the users when initiating a service application being the same, a reserved mobile phone number for credit investigation of a first user being the same as a mobile phone number of a contact person of a second user when applying for a business application, an application mobile phone number filled in by the first user when applying for the business being the same as the mobile phone number of the contact person of the second user when applying for the business, a bound mobile phone number of a bank card of the first user being the same as the mobile phone number of the contact person of the second user when applying for the business.

Inputting the target graph data into a graph neural network model to be trained for model iterative training to obtain a trained graph neural network model as a classification model. The specifically implementations of each model training could include the following steps: the node screening layer determines the node information of the first node based on the edge data between nodes of the target graph data and the feature information of the nodes, that is, the node screening layer performs structural importance appraisal and feature importance appraisal based on the edge data between nodes of the target graph data and the feature information of the nodes to obtain the node information of the first node; where the node information of the first node corresponds to the K first nodes selected from the P second nodes; K is an integer greater than 1 and less than P. The feature aggregation layer calculates the feature similarity between any second node and the neighborhood node of the second node among the K first nodes based on the node information of the first node. Based on the feature similarity and the feature information of the corresponding neighborhood node, feature aggregation is performed on the first node to obtain the aggregated feature information of the second node. The category prediction layer determines the predicted category label of the N labeled nodes based on the aggregated feature information, where the N labeled nodes include labeled nodes 1, . . . and labeled node N.

Based on the predicted category label and the real category label of the N labeled nodes, a total loss value is determined, and the parameter of the graph neural network model to be trained is updated based on the total loss value.

It should be noted that for the specific implementation process of the classification task being a task for classifying articles or a task for classifying pushed users, reference please be made to the above-mentioned specific implementation process of the classification task being the task for classifying risky users, which is not repeated here.

Considering the specific implementation process of selecting K first nodes from two dimensions of structural information richness and feature information discrimination of second nodes, in some example embodiments, it can first perform feature importance appraisal based on the feature information, and then perform structural importance appraisal based on the edge data; in other example embodiments, it can also first perform structural importance appraisal based on the edge data, and then perform feature importance appraisal based on the feature information. As the structural information can more intuitively affect the accuracy of feature aggregation, taking performing the structural importance appraisal first and then the feature importance appraisal as an example, for the determination process of the first node information, the determining the first node information based on the edge data and feature information corresponding to the first graph data in S1042 above specifically includes the following steps.

Step A1: determining first scores of the P second nodes based on the edge data between the P second nodes and the neighborhood node of the P second nodes.

Specifically, the first scores of the P second nodes are determined by performing structural importance appraisal on the P second nodes based on the edge data between the P second nodes and the neighborhood node of the P second nodes.

For each second node, based on the number of the connection edge between the second node and neighborhood node, a structural importance of the second node is scored to obtain the first scores. Among them, the larger the number of the connection edge between the second node and the neighborhood node, the greater the first scores. In the specific implementation, for a fixed graph data, the structural information of the graph data will not change. Therefore, the above step A1 can only be calculated once in the process of multiple rounds of model training.

In some example embodiments, the structural importance appraisal can be performed directly based on the structural information of each second node, and the feature importance appraisal can be performed based on an adjacency matrix corresponding to the P second nodes.

Step A2, determining feature information of M third nodes based on the first scores and the feature information corresponding to the first graph data; where the M third nodes third nodes are selected from the P second nodes, and M is greater than K and less than P.

A third node set (including the M third nodes) can be screen from the P second nodes based on the first scores. Considering that it needs to continue to perform feature importance appraisal on the node based on the feature information of the M third nodes in the future, it needs to locate the feature information of the M third nodes first, so as to provide basic data for calculating second scores of the M third nodes in the future.

Step A3, determining second scores of the M third nodes based on the feature information of the M third nodes.

Specifically, the second scores of the M third nodes are determined by performing feature importance appraisal on the M third nodes based on the feature information of the M third nodes.

After determining the feature information of the M third nodes, for each third node the feature importance of the third node is scored based on the feature information of the M third nodes to obtain the second scores. Among them, the higher a distinguishing degree of the feature information of the second node (that is, it includes more key information that is helpful to identify the node category), the greater the second scores.

In some example embodiments, the structural importance appraisal can be performed directly based on the feature information of each third node, and the structural importance appraisal can also be performed based on a feature matrix of the M third nodes.

A4, determining the node information of the K first nodes based on the second score.

A first node set (including K first nodes) can be screened from the M third nodes based on the second scores. Considering that it needs to calculate the feature similarity of the node based on the first node information in the future, it needs to determine the first node information based on relevant information of the above K first nodes, so as to provide basic data for the subsequent calculation of the feature similarity of the node. Among them, the first node information can be regarded as the relevant information of the K first nodes with rich structural information and high discrimination of the feature information screened after the structural importance appraisal of the nodes and the feature importance appraisal of the nodes.

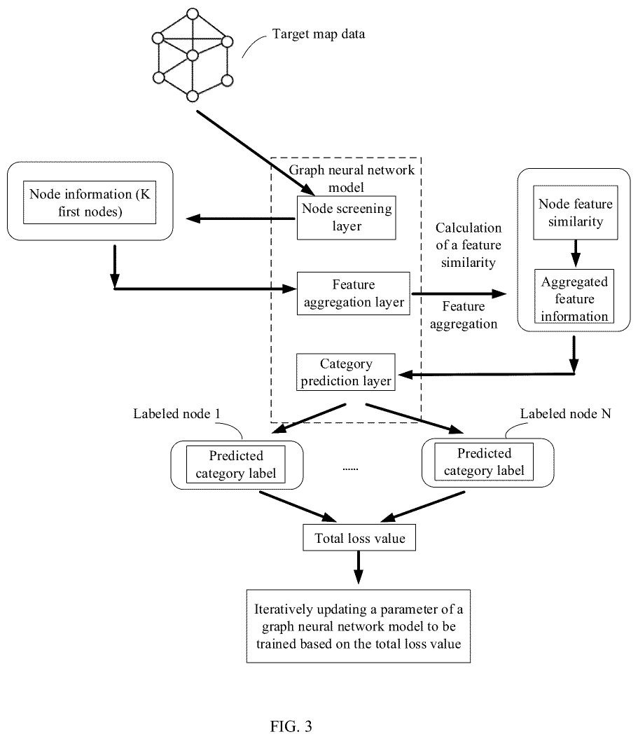

On the basis of the above-mentioned FIG. 3, for the determination process of the node information of the first node, as shown in FIG. 4, the specific implementation process of the data processing method is illustrated, which specifically includes: determining first scores of the P second nodes based on the edge data between the P second nodes and the neighborhood node of the P second nodes; determining feature information of M third nodes based on the first scores and feature information corresponding to target map data; where the M third nodes are selected from P second nodes; determining second scores of the M third nodes based on the feature information of the M third nodes; and determining the node information of the K first nodes based on the secondscore.

In view of the specific implementation of reducing the calculation amount of the feature similarity of the nodes from the perspective of the node structural richness of the, in order to simplify the processing process of the structure importance appraisal of the nodes and improve the accuracy of the first scores corresponding to the dimension of the structure importance appraisal dimension of the nodes, considering that a value of each element in the adjacency matrix represents whether there is a connection relationship between two nodes, it is possible to make full use of the adjacency matrix corresponding to the first graph data to score the structural richness degree of the P second nodes to obtain the first scores of the P nodes. Based on this, in the above step A1, the determining the first scores of the P second nodes based on the edge data between the P second nodes and the neighborhood node of the P second nodes specifically includes the following steps.

Step A11: determining a first matrix based on an adjacency matrix corresponding to the first graph data and a first reference matrix of the graph data.

The adjacency matrix is obtained based on the edge data between the nodes of the first graph data, the first reference matrix of the graph data is a column matrix including P preset values.

In some example embodiments, the adjacency matrix may be generated in advance based on the edge data between the nodes of the first graph data, or the adjacency matrix may be generated in real time based on the edge data between the nodes of the first graph data. Among them, a value of each element in the adjacency matrix indicates the connection relationship between two nodes (that is, whether there is a connection line). For example, the adjacency matrix is a (P×P) matrix A. If in the adjacency matrix, an element αᵢⱼ=1, it means that there is a connection line between the i-th second node and the j-th second node. If in the adjacency matrix, an element αᵢⱼ=0, it means that there is no connection line between the i-th second node and the j-th second node.

The values of P elements in the first reference matrix of the graph data are all preset values, which can be 1 or an integer greater than 1. As the adjacency matrix corresponding to the first graph data is a (P×P) matrix, P elements in a row of the (P×P) matrix consists a (1×P) row matrix, the row matrix represents connection relationships between a certain second node with itself and with other nodes. Take the values of P elements in the first reference matrix of the graph data being 1 as an example, that is, the first reference matrix of the graph data is a (P×1) column matrix with all elements being 1, in this way, the (1×P) row matrix corresponding to a certain second node is multiplied by the (P×1) column matrix (i.e. the first reference matrix of the graph data) corresponding to the same, and an obtained numerical value indicates the number of neighborhood nodes that have connection relationship with the second node, and the larger the numerical value, the more neighborhood nodes of the second node are, that is, the richer the structural information of the second node is. Therefore, this numerical value can be regarded as the first scores of the second node. Correspondingly, the adjacency matrix corresponding to the first graph data is multiplied by the first reference matrix of the graph data to obtain a first matrix, and the first matrix is also a (P×1) column matrix, and the values of elements in the first matrix correspond to the first scores of the P second nodes one by one, that is, the value of one element in the first matrix is the first score of the corresponding second node.

In some example embodiments, the following formula can be used to multiply the adjacency matrix and the first reference matrix of the graph data to obtain the first matrix, which is:

S=AE

where, S represents the first matrix (which can be used as a vector of the first scores of the nodes), S ∈ [symbol] , A represents the adjacency matrix (which can be used as a square matrix representing the node structure information), A ∈ [symbol] , E represents the first reference matrix of the graph data (which can be a column matrix with elements all being a preset value, for example, the preset value is 1), E ∈ [symbol] , that is, the adjacency matrix of (P×P) is multiplied by the first reference matrix of the graph data of (P×1) to obtain the first matrix of (P×1).

Step A12: determining the first scores of the P second nodes based on the first matrix. In some example embodiments, the first matrix can be directly determined as the first scores, or it can also perform preset processing (such as a normalization processing, a score fine-tuning processing, etc.) on the first matrix, and use the first matrix after the preset processing as the first scores.

For a specific implementation of performing the node importance appraisal from two dimensions of node structural richness and node feature discrimination to reduce the calculation amount of the feature similarity of the node, after determining the first scores of the P second nodes, for a process of determining the feature information of M third nodes based on the first scores (that is, screening the M third nodes first, and then perform sparse processing on the feature information set, so as to provide basic data for the subsequent calculation of the second scores of the M third nodes). Similarly, in order to simplify the determination process of the feature information of the M third nodes and improve the determination accuracy of the feature information of the M third nodes, based on the above-mentioned first scores and by means of the process of obtaining the initial sparse node feature matrix from the corresponding initial matrix, the above-mentioned step A2 of determining the feature information of the M third nodes based on the first scores and the feature information corresponding to the first graph data specifically includes the following steps.

Step A21: determining a fifth matrix based on an initial matrix corresponding to the first graph data and the M third nodes.

The initial matrix is obtained based on the feature information corresponding to the first graph data, and the fifth matrix is a matrix including the feature information of the M third nodes. Specifically, the initial matrix can be obtained by performing a linear transformation on the node feature matrix corresponding to the first graph data, and the node feature matrix can be a feature matrix obtained by performing a conversion based on the feature information corresponding to the first graph data in advance.

Since the M third nodes with relatively high structural richness are preliminarily selected (which is equivalent to the primary screening process of the first nodes) from the evaluation dimension of the node structural information richness, and then sparse processing is performed on the initial matrix corresponding to the first graph data based on the M third nodes to obtain the node feature matrix (i.e. the fifth matrix) after preliminary sparse processing. In this way, the calculation amount of feature similarity between the fourth node with relatively low node structural richness and the central node (that is, any second node) is omitted, thus, the number of nodes participating in feature similarity is greatly reduced under the condition of ensuring the accuracy of the node feature aggregation, thus achieving the initial reduction of the calculation amount of feature similarity of the node (which is equivalent to initial sparse processing on the attention score).

The fifth matrix can be regarded as a matrix obtained by performing sparse processing on the feature information of the second nodes from the evaluation dimension of the structural information richness of the nodes, and then the fifth matrix is used as the basic data of the evaluation dimension of the feature discrimination degree of the nodes, so as to provide a basis for calculating the second scores of the M third nodes.

In some example embodiments, the following formula can be used to perform sparse processing on the initial matrix based on the node identities of the M third nodes to obtain the fifth matrix, which is:

H₁=(H₀)D₁

where H₁ represents the fifth matrix (that is, the node feature matrix obtained by performing preliminary sparse processing from the evaluation dimension of the structural information richness of the nodes), H₁ ∈ [symbol] , H₀ represents the initial matrix (that is, the node feature matrix after linear transformation and before the sparse processing), and H₀ ∈ [symbol] . D₁ represents the position information of the M third nodes, M=C₁ log (P), and C₁ is a scalar, that is, the initial matrix of (P×F) is transformed into the fifth matrix of (M×F).

Step A22: determining the feature information of the M third nodes corresponding to the first graph data based on the fifth matrix.

In some example embodiments, the fifth matrix can be directly determined as the feature information of the M third nodes, or it can also perform preset processing (such as a normalization processing, a feature fine-tuning processing, etc.) on the fifth matrix, and determine the fifth matrix after the preset processing as the feature information of the M third nodes.

In view of the specific implementation of reducing the calculation amount of the feature similarity of the node from the perspective of node feature discrimination, in order to simplify the processing process of the node feature importance appraisal and improve the accuracy of the secondscore corresponding to the node feature importance appraisal dimension, it is considered that the node feature importance can be scored by performing projection transformation on the node feature matrix (that is, paying attention to the important features of the nodes themselves). That is, a quantity of an element in a projection transformation matrix corresponding to the node feature matrix can reflect the feature importance degree of the nodes. Therefore, the second scores corresponding to the M third nodes can be obtained by making full use of the projection transformation matrix corresponding to the node feature matrix. In addition, as the feature importance appraisal of the nodes is realized on the basis of the node structure importance appraisal, that is, it needs to perform the feature importance appraisal of the M third nodes on the basis of the feature information of the M third nodes. Correspondingly, if the fifth matrix is directly determined as the feature information of the M third nodes during the node structure importance appraisal, the feature information of the M third nodes includes the fifth matrix, that is, the node feature importance appraisal is performed based on the fifth matrix. Based on this, the above step A3 of determining the second scores of the M third nodes based on the feature information of the M third nodes specifically includes the following steps.

Step A31: determining a second matrix based on the fifth matrix and the first parameter matrix.

The first parameter matrix is a (F×1) parameter matrix, the second matrix is a column matrix including the second scores of the M third nodes, and F is an integer greater than 1. Specifically, the first parameter matrix is related to a parameter to be trained in the model network layer itself, and F elements in the first parameter matrix correspond to a network layer parameter of an output dimension of a single-layer graph convolution calculation, that is, one element in the first parameter matrix corresponds to one network parameter of the output dimension.

In some example embodiments, the following formula can be used to perform projection transformation on the fifth matrix to obtain the second matrix, which is:

F₁=H₁W₁

where F₁ represents the second matrix (which can be used as a vector of the second scores of the nodes), F₁ ∈ [symbol] , H₁ represents the fifth matrix, H₁ ∈ [symbol] , W₁ represents the first parameter matrix (which can be used as a model parameter to be trained), W₁ ∈ [symbol] , that is, the fifth matrix of (M×F) is multiplied by the first parameter matrix of (F×1) to obtain the second matrix of (M×1).

Step A32, determining an eighth matrix based on the second matrix; where the eighth matrix is a column matrix including a difference between the second scores of the M third nodes and an average score; the average score may be an average value of the M second scores in the second matrix.

A value of each element in the above-mentioned eighth matrix is related to the above-mentioned preset constraint condition (i.e. a constraint condition used to define which element in the second matrix is set to zero). For example, if the preset constraint condition is to set an element in the second matrix whose second score is less than the average score to zero, the value of the M elements in the eighth matrix is the difference between the second scores of the M third nodes and the average score. For another example, if the preset constraint condition is to set an element whose second score in the second matrix is less than the preset threshold to zero, then the values of the M elements in the eighth matrix are the differences between the second scores of the M third nodes and the preset threshold. The preset constraint conditions can be set according to the actual needs, and no matter how they are set, they are within the protection scope of the present application.

Taking the above-mentioned preset constraint condition being that the element in the second matrix whose second score is less than the average score is set to zero as an example, the following formula is used to determine the eighth matrix, which can be:

$$\\ F = {F}_{1} - mean ( {F}_{1} )$$

where F represents the eighth matrix, F₁ represents the second matrix, and mean (F₁) represents the average matrix (that is, the values of the M elements are all average scores), that is, the average matrix of (M×1) is subtracted from the second matrix of (M×1) to obtain the eighth matrix of (M×1).

Step A33, determining a third matrix based on the second matrix and a second reference matrix; where the second reference matrix is determined based on the eighth matrix.

The determination process of the second reference matrix may include: if the value of any element in the eighth matrix is greater than a certain value (such as 0), the value of the corresponding element in the second reference matrix is 1; and if the value of any element in the eighth matrix is less than or equal to a certain value (such as 0), the value of the corresponding element in the second reference matrix is 0, that is, the second reference matrix is a 0-1 matrix.

In some example embodiments, the following formula can be used to determine the second reference matrix based on the eighth matrix, which can be:

$$\\ {F}^{{}_{} ′} = \{ \begin{matrix}1 , value of a corresponding element in F is greater than zero \\ 0 , value of a corresponding element in F is less than or equal to zero\end{matrix}$$

where F′ represents the second reference matrix (a 0-1 matrix used to constrain which element in the second matrix is set to zero), and F represents the eighth matrix, that is, the eighth matrix of (M×1) is converted into a 0-1 matrix of (M×1) (that is, the second reference matrix).

The value of any element in the third matrix is that an element in the second matrix is multiplied by a corresponding element in the second reference matrix, so that the element in the second matrix with the second score less than or equal to the average score is set to zero, while the element in the second matrix with the second score greater than the average score remains unchanged.

In some example embodiments, the following formula can be used to multiply the element in the second matrix by the corresponding element in the second reference matrix to obtain the third matrix, which can be:

$$\\ {F}_{2}^{{}_{} ′} = {F}^{{}_{} ′} * {F}_{1}$$

where F₂′ represents the third matrix, F′ represents the second reference matrix, F₁ represents the second matrix, and * represents the multiplication of elements, that is, the element in the second reference matrix of (M×1) is multiplied with the corresponding element in the second matrix of (M×1) to obtain the third matrix of (M×1), so that the element in the second matrix whose second score meet the preset constraint condition is set to zero.

Step A34: determining the secondscore of the M third nodes based on the third matrix.

The third matrix can be directly determined as the secondscore, so that a final second score of the third node in the secondscore whose second score is less than or equal to the average score (that is, the feature discrimination degree is relatively low) becomes zero.

Since in the secondscore, the corresponding final second score of the third node with low feature discrimination becomes zero, the K first nodes are selected from M third nodes based on the magnitude relationship of the scores representing feature importance in the secondscore, which can not only ensure the number of the first nodes finally screened out, but also ensure that only nodes with the second score greater than the average score will participate in the calculation of the feature similarity as the first neighborhood node of the second node. Even if the K first nodes include a second node with the second score less than or equal to the average score, the feature information of the first nodes will not affect the feature aggregation of the second node because the second score in the third matrix corresponding to that first node become zero.

For the specific implementation of performing node importance appraisal from two dimensions of node structural richness and node feature discrimination to reduce the calculation amount of the feature similarity of the node, after determining the secondscore that can represent the node second score, the process of determining the first node information based on the secondscore (that is, screening the K first nodes first, and then performing sparse processing on the feature information set or second score, so as to provide basic data for the subsequent calculation of the feature similarity of the node), specifically, the step A4 of determining the node information of K first nodes based on the secondscore specifically includes the following steps.

Step A41: determining a sixth matrix based on the K first nodes.

The sixth matrix is mainly used as the basic data for calculating the feature similarity of the node. As the feature similarity between two adjacent nodes can be calculated by comparing the node feature information, considering that the second score of the respective node is also obtained based on the information content included in the node feature information, the feature similarity between two adjacent nodes can also be calculated directly based on the second score of the respective node. In this way, it is unnecessary to compare and calculate the node feature information, which can further reduce the information calculation amount. Based on this, the first node information includes any one of the node feature information and the scores representing feature importance of the K first nodes, and correspondingly, the sixth matrix includes any one of a seventh matrix and a fourth matrix corresponding to the K first nodes, where the seventh matrix is a matrix including the feature information of the K first nodes, and the fourth matrix is a matrix including the scores representing feature importance of the K first nodes.

The sixth matrix can be regarded as a matrix obtained by performing sparse processing on the feature information of the second nodes or the second score from the evaluation dimension of the feature information discrimination of the nodes, and then the feature similarity between two adjacent nodes is calculated based on the sixth matrix.

In a case that the sixth matrix includes the fourth matrix, if the secondscore includes the second matrix, in specific implementation, the following formula is used to perform the sparse processing on the second matrix based on the node identifiers of the K first nodes to obtain the fourth matrix, which can be:

$$\\ {F}_{2} = {( {F}_{1} )}_{{D}_{2}}$$

where F₂ represents the fourth matrix, F₁ represents the second matrix, and D₂ represents position information of K first nodes, that is, sparse processing is performed on the second matrix of (M×1) to obtain the fourth matrix of (K×1) (that is, the sixth matrix).

In addition, in the case that the sixth matrix includes the fourth matrix, if the secondscore includes the third matrix, in the specific implementation, the following formula is used to perform sparse processing on the third matrix based on the node identifiers of the K first nodes to obtain the fourth matrix, which can be:

$$\\ {F}_{2} = {( {F}_{2}^{{}_{} ′} )}_{{D}_{2}}$$

where F₂ represents the fourth matrix, F₂′ represents the third matrix, and D₂ represents the position information of K first nodes, that is, sparse processing is performed on the third matrix of (M×1) to obtain the fourth matrix of (K×1) (that is, the sixth matrix).

Second nodes other than the K first nodes can be regarded as long-tail nodes with negligible attention scores, and these long-tail nodes can not participate in the calculation of the feature similarity of the node. As the long-tail nodes account for a large proportion of the P second nodes, the calculation amount of the feature similarity of the node can be greatly reduced. In addition, the number of nodes with a non-zero score in the fourth matrix F₂ is less than or equal to K, and the nodes with a zero score in the fourth matrix F₂ can also be regarded as long tail nodes. Although the long-tail nodes do not participate in the calculation of the feature similarity of the node, the long-tail nodes still participate in the calculation of graph convolution (that is, feature aggregation). Therefore, in the specific implementation, a unified weight can be used for the long-tail nodes as their attention scores (such as min (F₂)).

In another implementation, in a case that the sixth matrix includes the seventh matrix, the initial matrix can be used as the basic data of feature sparseness, and the following formula can be used to perform sparse processing on the initial matrix based on the node identifiers of the K first nodes to obtain the seventh matrix, which can be:

H₂=(H₀)D₂

where H₂ represents the seventh matrix (that is, the sixth matrix, which is a node feature matrix obtained by performing sparse processing from two evaluation dimensions of node importance, that is, node structure information and node feature information), H₂ ∈ [symbol] , H₀ represents the initial matrix, H₀ ∈ [symbol] . D₂ represents the position information of the K first nodes, K=C₂ log (P), c₂ is a scalar and c₁>c₂, that is, the initial matrix of (P×F) is transformed into the seventh matrix of (K×F) (that is, the second objective matrix).

In addition, in the case that the sixth matrix includes the seventh matrix, the fifth matrix can also be used as the basic data of the feature sparseness. In specific implementation, the following formula is used to perform sparse processing on the fifth matrix based on the node identifiers of the K first nodes to obtain the seventh matrix, which can be:

H₂=(H₁)D₂

where H₂ represents seventh matrix (that is, the sixth matrix, which is the node feature matrix obtained by performing sparse processing from two evaluation dimensions of node importance, that is, node structure information and node feature information), H₂ ∈ [symbol] , H₁ represents the fifth matrix, and H₁ ∈ [symbol] , D₂ represents the position information of the K first nodes, K=C₂ log (P), c₂ is the scalar and c₁>c₂, that is, the fifth matrix of (M×F) is transformed into the seventh matrix of (K×F) (that is, the sixth matrix).

In the case that the sixth matrix includes the seventh matrix, considering that if the sparse processing is performed on the initial matrix or the fifth matrix directly based on the node identifiers of the K first nodes to obtain the seventh matrix, there is also the problem that the seventh matrix obtained includes the feature information of the nodes with low feature discrimination. Therefore, in order to further improve the accuracy of the feature aggregation, the feature information of the M third nodes in the initial matrix or the fifth matrix whose second score meet the preset constraint condition (that is, the element with a zero value in the third matrix) also need to be set as zero to obtain a ninth matrix, and then sparse processing is performed on the ninth matrix based on the node identifiers of the K first nodes to obtain the seventh matrix.

On the basis of setting the feature information of the M third nodes in the fifth matrix whose second score meet the preset constraint condition as zero to obtain the ninth matrix, the following formula is used to perform sparse processing on the ninth matrix based on the K first nodes to obtain the seventh matrix, which can be:

H₂=(H₁′)D₂

where H₂ represents the seventh matrix, H₁′ represents the ninth matrix, and D₂ represents the position information of the K first nodes, that is, sparse processing is performed on the ninth matrix of (M×F) to obtain the seventh matrix of (K×F) (that is, the sixth matrix).

As the feature similarity between two adjacent nodes is calculated directly based on the second score of the respective node, it is not necessary to compare and calculate the node feature information, which can further reduce information calculation amount. Therefore, it is preferable that the sixth matrix includes the fourth matrix.

Step A42: determining the first node information corresponding to the first graph data based on the sixth matrix.

The sixth matrix can be directly determined as the first node information, or it can also perform preset processing (such as a normalization processing, a feature fine-tuning processing, etc.) on the sixth matrix to determine the sixth matrix after the preset processing as the first node information.

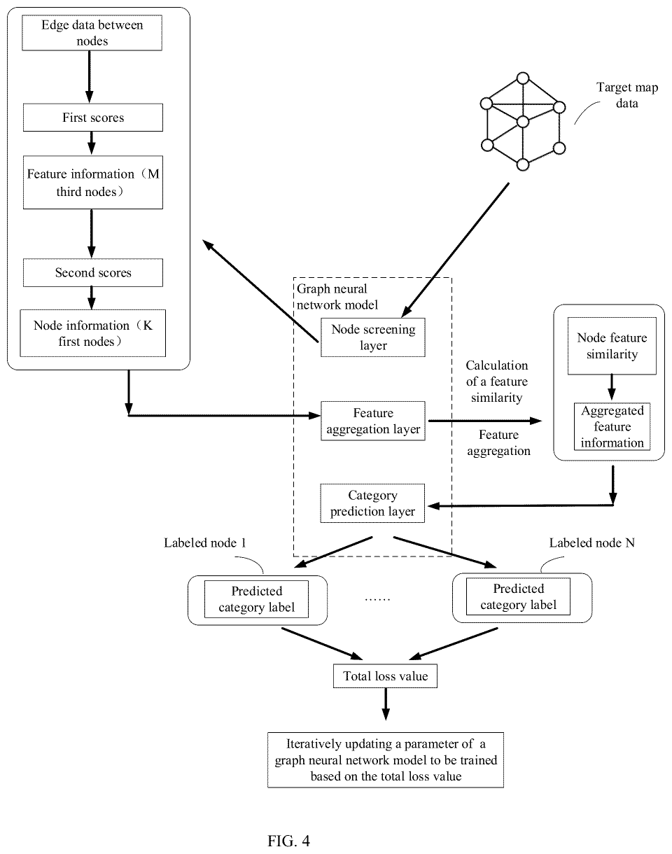

On the basis of the above-mentioned FIG. 4, as shown in FIG. 5, a more specific implementation process is given for the determination process of the node information of the K first nodes, which specifically includes: determining a first matrix based on the adjacency matrix corresponding to the target graph data and the first reference matrix of the graph data, that is, performing the structural importance appraisal based on the adjacency matrix and the first reference matrix of the graph data to obtain the first matrix; where the adjacency matrix is obtained based on the edge data between the nodes of the target graph data, the first reference matrix of the graph data is a column matrix including P preset values; determining first scores of the P second nodes based on the first matrix; determining a fifth matrix based on an initial matrix and the M third nodes corresponding to the target map data; where the initial matrix is obtained based on the feature information corresponding to the target map data, and the fifth matrix is a matrix including the feature information of M third nodes; determining a second matrix based on the fifth matrix (corresponding to the feature information of the M third nodes) and the first parameter matrix, that is, performing feature importance appraisal based on the fifth matrix and the first parameter matrix to obtain the second matrix; determining an eighth matrix based on the second matrix; determining a third matrix based on the second matrix and a second reference matrix; determining the secondscore of the M third nodes based on the third matrix; determining a sixth matrix based on the K first nodes; and determining the node information of the K fits nodes based on the sixth matrix.

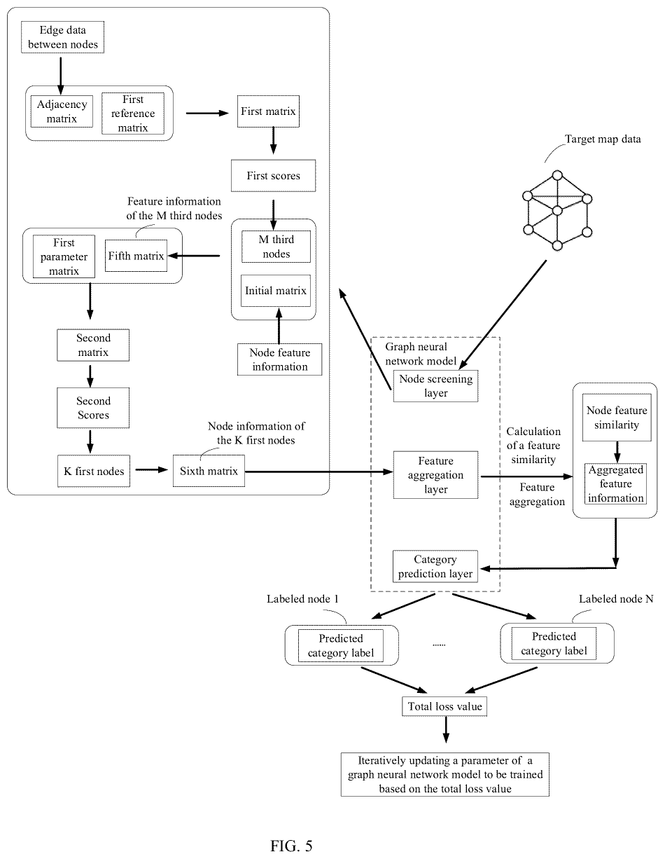

On the basis of the above-mentioned FIG. 5, for the process of determining the secondscore of the M third nodes based on the feature information of the M third nodes, taking the sixth matrix including the fourth matrix as an example, as shown in FIG. 6, it further includes: determining an eighth matrix based on the second matrix; where the eighth matrix is a column matrix including a difference between the second scores of the M third nodes and the average score; determining a third matrix based on the second matrix and the second reference matrix; where the second reference matrix is determined based on the eighth matrix; and determining secondscore s of the M third nodes based on the third matrix.

After screening the K first nodes and determining the sixth matrix from two dimensions of structural information richness and feature information discrimination of second nodes, for the calculation process of the feature similarity of the node, only the feature similarity between the central node (i.e., any second node) and the corresponding first neighborhood node (i.e., the neighborhood node of the central node among the K first nodes) can be calculated, where if in the process of node feature importance appraisal, the sixth matrix is directly determined as the first node information, so that the first node information includes the sixth matrix, that is, the feature similarity of the node is calculated based on the sixth matrix. Specifically, in step S1044, the calculating the feature similarity between the second node and the neighborhood node of the second node among the K first nodes based on the first node information specifically includes: calculating the feature similarity between the second node and the neighborhood node of the second node among the K first nodes based on the sixth matrix.

The sixth matrix include any one of the seventh matrix and the fourth matrix. The neighborhood node of the second node among the K first nodes includes the first neighborhood node corresponding to the second node (i.e., a first-order first neighborhood node of the second node among the k first nodes). Specifically, for a certain central node (that is, any second node), the first neighborhood node corresponding to the central node is determined based on the adjacency matrix corresponding to the first graph data, that is, a second node with an element value of 1 in the row matrix and a column number corresponding to a certain first node is determined based on a row matrix in the adjacency matrix corresponding to the second node.

In the case that the sixth matrix includes the seventh matrix, the feature similarity between the feature information of the second node and the feature information of the first neighborhood node of the second node can be calculated based on the seventh matrix. For the process of calculating the feature similarity between the second node and its first neighborhood node based on the seventh matrix, the following formula can be adopted, specifically:

$$\\ {e}_{ij} = LeakyRe LU ( {a}^{{}_{} T} [ {z}_{i} ‖ {z}_{j} ] )$$

where eᵢⱼ represents a feature similarity between node i and node j, LeakyReLU represents an activation function, ∥ represents a vector stitching operation, a^{T} represents a parameter to be trained for projecting a stitched vector into a one-dimensional vector, Zᵢ represents a feature vector of node i, Zᵢ ∈ H₂, Zⱼ represents a feature vector of node j, and Zᵢ ∈ H₂.

The magnitude relationship between the scores representing feature importance of the two nodes can reflect the feature similarity between the second node and the first neighborhood node to a certain extent, the scores representing feature importance of the two nodes are close with each other and the scores are both relatively large, the higher the feature similarity between the two nodes. Based on this, the sixth matrix can also include the fourth matrix, and the feature similarity between the second node and the first neighborhood node can be calculated based on the fourth matrix. At this time, there is no need to compare and calculate the node feature information, which can further reduce the information calculation amount. Therefore, the feature similarity between the second node and the neighborhood node (i.e., the first neighborhood node) of the second node among the K first nodes can also be calculated based on the fourth matrix.

For the process of calculating the feature similarity between the second node and its first neighborhood node based on the fourth matrix, the following formula can be adopted, specifically:

$$\\ {e}_{ij} = LeakyRe LU ( {y}_{i} + {y}_{j} )$$

where eᵢⱼ represents the feature similarity between node i and node j, LeakyReLU represents the activation function, yᵢ represents the second score of node i, where yᵢ ∈ F₂, and y represents the second score of node j, where yᵢ ∈ F₂^{T}.

In addition, the feature similarity can be directly used as the weight coefficient, or it can also perform normalization processing on the feature similarity first, and use the normalized feature similarity as the weight coefficient.

For the determination process of the initial matrix corresponding to the first graph data, the specific implementation of each model training also includes: determining the initial matrix based on the node feature matrix corresponding to the first graph data and a second parameter matrix; where the node feature matrix is obtained based on the feature information corresponding to the first graph data, each row in the node feature matrix corresponds to C feature dimensions of a second node, the second parameter matrix is a (C×F) parameter matrix, and both C and F are integers greater than 1.

In some example embodiments, the following formula can be used to multiply the node feature matrix and the second parameter matrix to obtain the initial matrix, which can be:

H₀=XW₀

where H₀ represents the initial matrix, H₀ ∈ [symbol] , X represents the node feature matrix, X ∈ [symbol] , W₀ represents the second parameter matrix (which can be used as a model parameter to be trained), and W₀ ∈ [symbol] . That is, the node feature matrix of (P×C) is multiplied by the second parameter matrix of (C×F) to obtain the initial matrix of (P×F).

As in the model training stage, when calculating the feature similarity of the node, for a certain central node (that is, any second node), it is only necessary to calculate the feature similarity between the central node and the neighborhood node of the central node among the K first nodes with rich structure and high feature discrimination, which greatly reduces the overall calculation amount in the model training stage. Therefore, the prediction of node category can be completed together in the model training process. Based on this, the P second nodes also include (P−N) unlabeled nodes, and the (P−N) unlabeled nodes include X nodes to be classified, and the prediction result also includes a predicted category label of the (P−N) unlabeled nodes.

After inputting the first graph data to the classification model to be trained for model iterative training in S104, it further includes: determining a predicted category label of X nodes to be classified based on the prediction result output by the last round of training of the classification model, where X is an integer greater than or equal to 1.

The P second nodes include not only a labeled node for calculating a parameter loss value, but also a first unlabeled node for providing more feature information during feature aggregation and a second unlabeled node used as the node to be classified, that is, the P second nodes include N labeled nodes (sampled nodes), X second unlabeled nodes (nodes to be classified) and (P−N-X) first unlabeled nodes (sampled nodes).

For the prediction process of node category, one implementation way is that the model training stage and the prediction of node category stage are executed separately, that is, the predicted category label of the node to be classified is executed after the model training is completed, where the above (P−N) unlabeled nodes only include sampled nodes, but not include the nodes to be classified. Another implementation way is that the model training stage is executed together with the prediction stage of node category, that is, the predicted category label of the nodes to be classified can be obtained in the last round of model training, where the (P−N) unlabeled nodes not only include sampled nodes, but also include nodes to be classified, and the nodes to be classified can participate in the iterative training of model parameter as the unlabeled nodes in the model training stage, and then, the predicted category label of the nodes to be classified can be determined based on the prediction result of the last round (that is, the model training has been completed, and the prediction result is accurate at this time, so the predicted category label of the node to be classified can be directly determined).

For the specific application scenario of classification using the graph neural network model (i.e., the classification model), the S102 of acquiring the first graph data corresponding to the classification task specifically includes the following.

(1) If the classification task is a task for classifying articles, first graph data corresponding to the task for classifying articles is obtained, where the second node includes an article node.

The classification model can be a graph neural network model used for article classification, and the first graph data including P article nodes is input to the graph neural network model to be trained for model iterative training to obtain a trained graph neural network model as the classification model. Specifically, each second node corresponds to an article, and if there is a preset association relationship (such as a citation relationship) between two articles, there is a connection edge between second nodes corresponding to the two articles.

(2) If the classification task is a task for classifying risky users, first graph data corresponding to the task for classifying risky users is obtained, where the second node includes a user node.

The first graph data can be constructed based on a social network graph, the user node corresponds to a certain user in the social network graph, and the classification model can be a graph neural network model for identifying a risky user. The first graph data including P second nodes is input to the graph neural network model to be trained for model iterative training to obtain a trained graph neural network model as the classification model. Specifically, each second node corresponds to a user, and if there is a preset association relationship (such as a transfer transaction) between two users, there is a connection edge between second nodes corresponding to the two users.

(3) If the classification task is a task for classifying pushed users, first graph data corresponding to the task for classifying pushed users is obtained, where the second node includes a user node.

The first graph data can be constructed based on a friend relationship graph, the user node corresponds to a certain user in the friend relationship graph, and the classification model can be a graph neural network model used for identifying a target pushed user. The first graph data including P second nodes is input to the graph neural network model to be trained for model iterative training to obtain a trained graph neural network model as the classification model. Specifically, each second node corresponds to a user, and if there is a preset association relationship (such as a friend relationship) between two users, there is a connection edge between second nodes corresponding to the two users.

In the data processing method in the embodiment of the present application, firstly, node information is screened out based on node edge data and node feature information, that is, K first nodes with rich structure and high feature discrimination are located, and then the feature similarity is calculated based on relevant information of the first node, so that a fourth node will not participate in the calculation of the feature similarity as the first neighborhood node of the central node (that is, any second node), so that sparse processing is performed on the neighborhood node of the central node, thus reducing the calculation amount of the feature similarity of the nodes (that is, the calculation amount of the attention scores of the central node and some neighborhood nodes is omitted), and improving training efficiency of the model. On the other hand, as the calculation amount of the feature similarity of the nodes can be accurately controlled to be relatively small in the model training stage, for a situation that the classification model training and prediction of node category are completed at the same time, that is, the second node can include a node to be classified, the category prediction efficiency of the node to be classified can still be ensured. Moreover, as the model parameter used in the category prediction is obtained through iteratively updating a parameter by taking the node to be classified as an unlabeled node, the accuracy of the model parameter is improved, and the effect of considering both category prediction efficiency and prediction accuracy can be achieved.

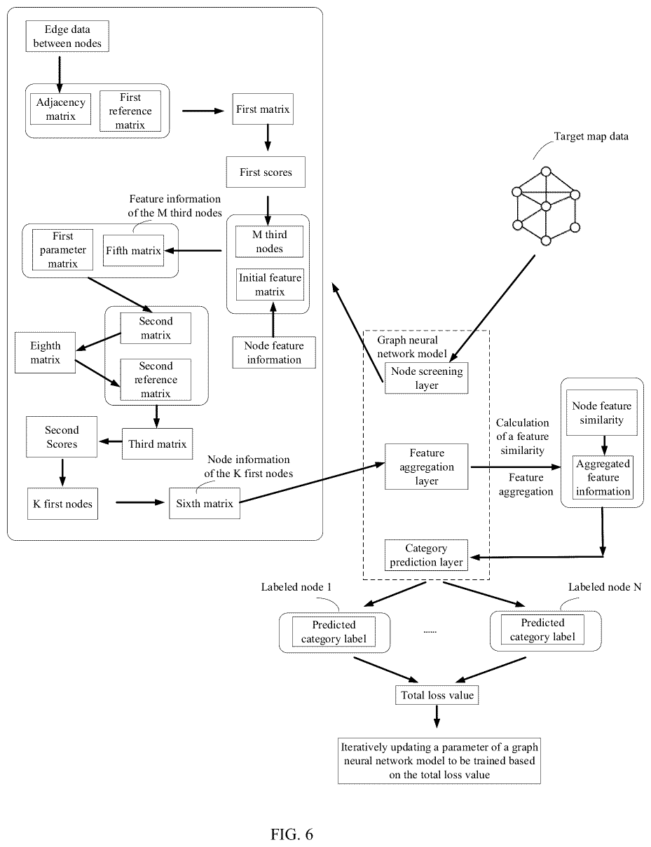

Corresponding to the data processing methods described in FIG. 1 to FIG. 6, based on the same technical concept, an embodiment of the present application further provides a class identification method for the case that model training and prediction of node category are performed separately. FIG. 7A is a flow chart of a class identification method provided by an embodiment of the present application, and the method in FIG. 7A can be performed by an electronic device, the electronic device can be a terminal device or a designated server. The classification model can be applied to any application scenario that needs to classify a node in the graph data, for example, to predict a category of an article node to be tested in the graph data, for another example, to predict a category of a user node to be identified in the graph data (for example, identifying whether the user applying for loan business is a risky user, or identifying whether a registered user of the preset application is a pushed user of a target commodity, etc.). As shown in FIG. 7A, the method at least includes the following steps.

S700: determining node information of a first node based on graph data, where the graph data includes a node to be classified and a sampled node, and the node to be classified and the sampled node include the first node.

The above graph data may include second graph data corresponding to a classification task, and the second graph data may include a node to be classified and a sampled node, as well as node feature information and edge data between the nodes.

S800, calculating feature similarity between the node to be classified and a neighborhood node of the node to be classified based on the node information, aggregates feature information of the node to be classified based on the feature similarity and feature information of the neighborhood node.

The neighborhood node can be a neighborhood node of the node to be classified among the first nodes, that is, the neighborhood node of the node to be classified refers to a first node with a connection edge with the node to be classified among a plurality of first nodes screened, and can also be called a first neighborhood node of the node to be classified.

S900, determining predicted category information of the node to be classified based on the aggregated feature information.

In some example embodiments, taking the graph data including the second graph data corresponding to the classification task as an example, as shown in FIG. 7B, the category identification method at least includes the following steps.

S702, acquiring second graph data corresponding to a classification task; where the second graph data includes X nodes to be classified and Q sampled nodes as well as node feature information and edge data between the nodes, each node to be classified is used to represent an object to be classified, and the object to be classified includes any one of an article to be classified and a user to be classified, and both X and Q are integers greater than or equal to 1.

The Q sampled nodes may include sampled nodes used in the training process of the classification model, where Q is less than or equal to P. The above classification task may include any one of a task for classifying articles, a task for classifying risky users and a task for classifying pushed users.

S704: inputting the second graph data into a trained classification model for prediction of node category to obtain predicted category information of the X nodes to be classified.

The above classification model can be a graph neural network model (such as a graph attention network model). The trained classification model can be obtained by performing model iterative training on the classification model to be trained based on the above data processing method, and the specific implementation process is detailed in the above steps S102 and S104, which will not be repeated here.

The specific implementation of the above prediction of node category is as follows:

Determining second node information based on the second graph data, where the second node information corresponds to L first nodes selected from (X+Q) nodes; L is an integer greater than 1 and less than (X+Q).

The determination process of the second node information can be referred to the determination process of the first node information mentioned above, and will not be repeated it here.

Calculating the feature similarity between the node to be classified and a neighborhood node of the node to be classified among the L first nodes based on the second node information; aggregates feature of the node to be classified based on the feature similarity and the feature information of the corresponding neighborhood node to obtain the aggregated feature information of the node to be classified; where the neighborhood node of the node to be classified among the L first nodes refers to a first node with a connection edge with the node to be classified among the L first nodes, that is, a first node with a preset association relationship with the node to be classified among the L first nodes, that is, a first neighborhood node of the node to be classified.

The determination process of the feature similarity between the node to be classified and the corresponding first neighborhood node can be referred to the determination process of the feature similarity between the second node and the neighborhood node of the second node among the K first nodes, which is not repeated here. In addition, the feature aggregation process can also be referred to the above embodiment, and will not be repeated here.

Determining the predicted category information of the X nodes to be classified based on the aggregated feature information.

In addition, in the case of adding X nodes to be classified, if preset information required in the category prediction process remains unchanged, the preset information determined in the model training stage can be directly acquired without repeated determination. For example, the feature similarity between two nodes in the Q sampled nodes will not change because the X nodes to be classified are added to the graph data, therefore, for the feature similarity between the sampled nodes, that calculated in the model training stage can be directly used.

For the specific application scenario of performing classification by using the graph neural network model (i.e. the classification model), the S702 of acquiring the second graph data corresponding to the classification task specifically includes:

(1) if the classification task is a task for classifying articles, acquiring the second graph data corresponding to the task for classifying articles, where both the nodes to be classified and the sampled nodes include an article node;

(2) if the classification task is a task for classifying risky users, acquiring the second graph data corresponding to the task for classifying risky users, where both the nodes to be classified and the sampled nodes include a user node; and

(3) if the classification task is a task for classifying pushed users, acquiring the second graph data corresponding to the task for classifying pushed users, where both the nodes to be classified and the sampled nodes include the user node.

In the class identification method in the embodiment of the present application, no matter in the model training stage or the prediction stage of node category, node information can be screened out first based on node edge data and node feature information, that is, a plurality of first nodes with rich structure and high feature discrimination can be located, and then the feature similarity can be calculated based on relevant information of the first nodes. In this way, a fourth node will not participate in the calculation of the feature similarity as a first neighborhood node of a central node (that is, any second node), so that sparse processing will be performed on the neighborhood node of the central node, thus reducing the calculation amount of the feature similarity of the node (that is, the calculation amount of the attention scores of the central node and some neighborhood nodes is omitted), and further improving the efficiency of category prediction. In addition, because more unlabeled nodes can be added to participate in the iterative updating of the model parameter in the model training stage, the accuracy of the trained model parameter is higher, and then the accuracy of the category prediction is higher.

It should be noted that this embodiment in the present application is based on the same inventive concept as the former embodiment in the present application, so the specific implementation of this embodiment can refer to the implementation of the aforementioned data processing method, and is not repeated here.

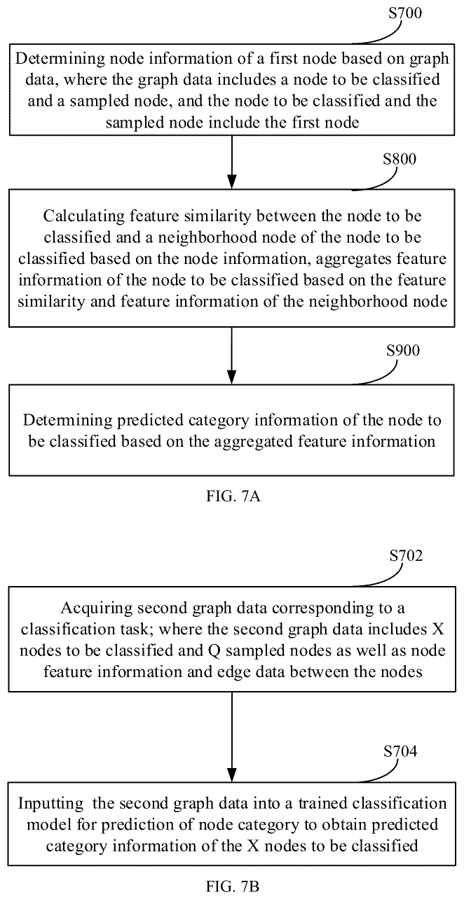

Corresponding to the data processing methods described in FIG. 1 to FIG. 6, based on the same technical concept, an embodiment of the present application also provides a data processing apparatus. FIG. 8 is a schematic diagram of a module composition of a data processing apparatus provided by an embodiment of the present application, which is used to execute the data processing methods described in FIG. 1 to FIG. 6. As shown in FIG. 8, the apparatus includes a graph data acquisition module 802, configured to acquire first graph data corresponding to a classification task; where the first graph data includes P second nodes, feature information of the second nodes and edge data between the second nodes, the P second nodes include N labeled nodes, and both P and N are integers greater than 1 and N is less than P; and a model training module 804, configured to input the first graph data into a classification model to be trained for model iterative training. A specific implementation method of each model training is as follows: determining first node information based on the edge data and the feature information; where the first leading node information corresponds to K first nodes selected from the P second nodes; K is an integer greater than 1 and less than P; calculating feature similarity between the second node and a neighboring nodes of the second node among the K first nodes based on the first node information; aggregating feature information of the second node based on the feature similarity and the feature information of the neighboring node; determining a prediction result based on the aggregated feature information; where the prediction result includes a predicted category label of N labeled nodes; and updates a parameter of the classification model based on the predicted category label of the N labeled nodes and a real category label of the labeled node.

In the data processing apparatus in the embodiment of the present application, firstly, node information is screened out based on node edge data and node feature information, that is, K first nodes with rich structure and high feature discrimination are located, and then the feature similarity is calculated based on relevant information of the first node, so that a fourth node will not participate in the calculation of the feature similarity as the first neighborhood node of the central node (that is, any second node), so that sparse processing is performed on the neighborhood node of the central node, thus reducing the calculation amount of the feature similarity of the nodes (that is, the calculation amount of the attention scores of the central node and some neighborhood nodes is omitted), and improving training efficiency of the model. On the other hand, as the calculation amount of the feature similarity of the nodes can be accurately controlled to be relatively small in the model training stage, for a situation that the classification model training and prediction of node category are completed at the same time, that is, the second node can include a node to be classified, the category prediction efficiency of the node to be classified can still be ensured. Moreover, as the model parameter used in the category prediction is obtained through iteratively updating a parameter by taking the node to be classified as an unlabeled node, the accuracy of the model parameter is improved, and the effect of considering both category prediction efficiency and prediction accuracy can be achieved.

It should be noted that the embodiment of the data processing apparatus in the present application is based on the same inventive concept as the embodiment of the data processing method in the present application, so the specific implementation of this embodiment can be referred to the implementation of the corresponding data processing method mentioned above, and is not repeated here.

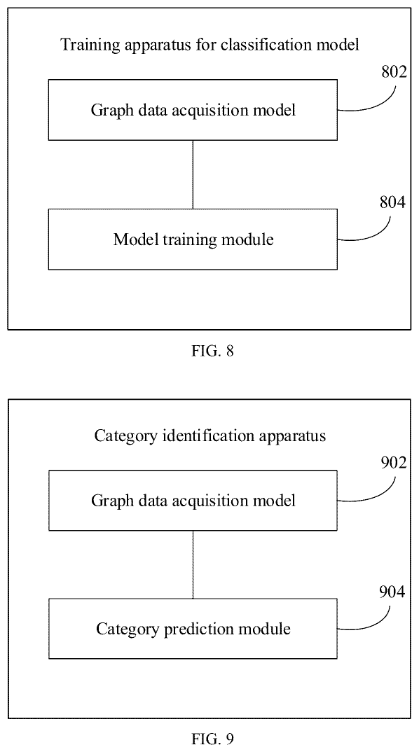

Corresponding to the above-mentioned category identification method described in FIG. 7A and based on the same technical concept, this embodiment of the present application also provides a category identification apparatus. FIG. 9 is a schematic diagram of the module composition of the category identification apparatus provided by this embodiment of the present application, which is used for executing the category identification method described in FIG. 7A, as shown in FIG. 9, the apparatus includes: a graph data acquisition module 902, configured to acquire second graph data corresponding to a classification task; where the second graph data includes X nodes to be classified and Q sampled nodes, each node to be classified is used to represent an object to be classified, and the object to be classified includes any one of an article to be classified and a user to be classified, and both X and Q are integers greater than or equal to 1; and a category prediction module 904, configured to input the second graph data into a trained classification model for prediction of node category to obtain predicted category information of the nodes to be classified. The specific implementation of the prediction of node category is: determining second node information based on the second graph data, where the second node information corresponds to L first nodes selected from (X+Q) nodes; L is an integer greater than 1 and less than (X+Q); calculating the feature similarity between the node to be classified and a neighborhood node of the node to be classified among the L first nodes based on the second node information; aggregating feature information of the node to be classified based on the feature similarity and the feature information of the corresponding neighborhood node to obtain the aggregated feature information of the node to be classified; and determining the predicted category information of the X nodes to be classified based on the aggregated feature information.

In the class identification apparatus in the embodiment of the present application, no matter in the model training stage or the prediction stage of node category, node information can be screened out first based on node edge data and node feature information, that is, a plurality of first nodes with rich structure and high feature discrimination can be located, and then the feature similarity can be calculated based on relevant information of the first nodes. In this way, a fourth node will not participate in the calculation of the feature similarity as a first neighborhood node of a central node (that is, any second node), so that sparse processing will be performed on the neighborhood node of the central node, thus reducing the calculation amount of the feature similarity of the node (that is, the calculation amount of the attention scores of the central node and some neighborhood nodes is omitted), and further improving the efficiency of category prediction. In addition, because more unlabeled nodes can be added to participate in the iterative updating of the model parameter in the model training stage, the accuracy of the trained model parameter is higher, and then the accuracy of the category prediction is higher.

It should be noted that the embodiment of the class identification apparatus in the present application is based on the same inventive concept as the embodiment of the class identification method in the present application, so the specific implementation of this embodiment can be referred to the implementation of the corresponding class identification method mentioned above, and is not repeated here.

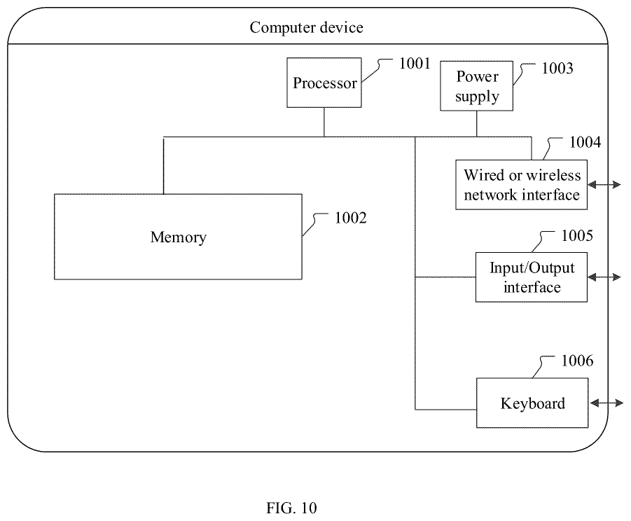

Corresponding to the methods shown in FIG. 1 to FIG. 7B, based on the same technical concept, an embodiment of the present application further provides a computer device, which is used to execute the data processing method above and is illustrate in FIG. 10.

A computer device may vary greatly due to different configurations or performances, and may include one or more processors 1001 and a memory 1002, in the memory 1002, one or more storage applications or data may be stored. Among them, the memory 1002 can be a temporary storage or a permanent storage. The application stored in the memory 1002 may include one or more modules (not shown), and each module may include a series of computer-executable instructions in a computer device. Further, the processor 1001 may be arranged to communicate with the memory 1002 and execute a series of computer-executable instructions in the memory 1002 on the computer device. The computer device may also include one or more power supplies 1003, one or more wired or wireless network interfaces 1004, one or more input and output interfaces 1005, and one or more keyboards 1006, etc.

The computer device includes a memory and one or more programs, where the one or more programs are stored in the memory, and the one or more programs may include one or more modules, and each module may include a series of computer-executable instructions in the computer device, and the one or more programs configured to be executed by one or more processors includes the computer-executable instructions to execute the following operations: acquiring first graph data corresponding to a classification task; where the first graph data includes P second nodes, feature information of the second nodes and edge data between the second nodes, the P second nodes include N labeled nodes, and both P and N are integers greater than 1 and N is less than P; inputting the first graph data into a classification model to be trained for model iterative training. A specific implementation method of each model training is as follows: determining first node information based on the edge data and the feature information; where the first leading node information corresponds to K first nodes selected from the P second nodes; K is an integer greater than 1 and less than P; calculating feature similarity between the second node and a neighboring nodes of the second node among the K first nodes based on the first node information; aggregating feature information of the second node based on the feature similarity and the feature information of the neighboring node; determining a prediction result based on the aggregated feature information; where the prediction result includes a predicted category label of N labeled nodes; and updating a parameter of the classification model based on the predicted category label of the N labeled nodes and a real category label of the labeled node.

The computer device includes a memory and one or more programs, where the one or more programs are stored in the memory, and the one or more programs may include one or more modules, and each module may include a series of computer-executable instructions in the computer device, and the one or more programs configured to be executed by one or more processors includes the computer-executable instructions to execute the following operations: acquiring second graph data corresponding to a classification task; where the second graph data includes X nodes to be classified and Q sampled nodes, each node to be classified is used to represent an object to be classified, and the object to be classified includes any one of an article to be classified and a user to be classified, and both X and Q are integers greater than or equal to 1; and inputting the second graph data into a trained classification model for prediction of node category to obtain predicted category information of the nodes to be classified. The specific implementation of the prediction of node category is: determining second node information based on the second graph data, where the second node information corresponds to L first nodes selected from (X+Q) nodes; L is an integer greater than 1 and less than (X+Q); calculating the feature similarity between the node to be classified and a neighborhood node of the node to be classified among the L first nodes based on the second node information; aggregating feature information of the node to be classified based on the feature similarity and the feature information of the corresponding neighborhood node to obtain the aggregated feature information of the node to be classified; and determining the predicted category information of the X nodes to be classified based on the aggregated feature information.

In the computer device in the embodiment of the present application, firstly, node information is screened out based on node edge data and node feature information, that is, K first nodes with rich structure and high feature discrimination are located, and then the feature similarity is calculated based on relevant information of the first node, so that a fourth node will not participate in the calculation of the feature similarity as the first neighborhood node of the central node (that is, any second node), so that sparse processing is performed on the neighborhood node of the central node, thus reducing the calculation amount of the feature similarity of the nodes (that is, the calculation amount of the attention scores of the central node and some neighborhood nodes is omitted), and improving training efficiency of the model. On the other hand, as the calculation amount of the feature similarity of the nodes can be accurately controlled to be relatively small in the model training stage, for a situation that the classification model training and prediction of node category are completed at the same time, that is, the second node can include a node to be classified, the category prediction efficiency of the node to be classified can still be ensured. Moreover, as the model parameter used in the category prediction is obtained through iteratively updating a parameter by taking the node to be classified as an unlabeled node, the accuracy of the model parameter is improved, and the effect of considering both category prediction efficiency and prediction accuracy can be achieved.

It should be noted that the embodiment of the computer device in the present application is based on the same inventive concept as the embodiment of the data processing method in the present application, so the specific implementation of this embodiment can be referred to the implementation of the corresponding data processing method mentioned above, and is not repeated here.

Corresponding to the method shown in FIG. 1 to FIG. 7B, based on the same technical concept, an embodiment of the present application further provides a storage medium for storing computer-executable instructions, the storage medium can be a U disk, an optical disk, a hard disk, etc. When the computer-executable instructions stored in the storage medium are executed by a processor, the following processes can be realized: acquiring first graph data corresponding to a classification task; where the first graph data includes P second nodes, feature information of the second nodes and edge data between the second nodes, the P second nodes include N labeled nodes, and both P and N are integers greater than 1 and N is less than P; inputting the first graph data into a classification model to be trained for model iterative training. A specific implementation method of each model training is as follows: determining first node information based on the edge data and the feature information; where the first leading node information corresponds to K first nodes selected from the P second nodes; K is an integer greater than 1 and less than P; calculating feature similarity between the second node and a neighboring nodes of the second node among the K first nodes based on the first node information; aggregating feature information of the second node based on the feature similarity and the feature information of the neighboring node; determining a prediction result based on the aggregated feature information; where the prediction result includes a predicted category label of N labeled nodes; and updating a parameter of the classification model based on the predicted category label of the N labeled nodes and a real category label of the labeled node.

The storage medium can be a U disk, an optical disk, a hard disk, etc. When the computer-executable instructions stored in the storage medium are executed by a processor, the following processes can be realized: acquiring second graph data corresponding to a classification task; where the second graph data includes X nodes to be classified and Q sampled nodes, each node to be classified is used to represent an object to be classified, and the object to be classified includes any one of an article to be classified and a user to be classified, and both X and Q are integers greater than or equal to 1; and inputting the second graph data into a trained classification model for prediction of node category to obtain predicted category information of the nodes to be classified. The specific implementation of the prediction of node category is: determining second node information based on the second graph data, where the second node information corresponds to L first nodes selected from (X+Q) nodes; L is an integer greater than 1 and less than (X+Q); calculating the feature similarity between the node to be classified and a neighborhood node of the node to be classified among the L first nodes based on the second node information; aggregating feature information of the node to be classified based on the feature similarity and the feature information of the corresponding neighborhood node to obtain the aggregated feature information of the node to be classified; and determining the predicted category information of the X nodes to be classified based on the aggregated feature information.

When the computer-executable instructions stored in the storage medium in the embodiment of the present application are executed by the processor, firstly, node information is screened out based on node edge data and node feature information, that is, K first nodes with rich structure and high feature discrimination are located, and then the feature similarity is calculated based on relevant information of the first node, so that a fourth node will not participate in the calculation of the feature similarity as the first neighborhood node of the central node (that is, any second node), so that sparse processing is performed on the neighborhood node of the central node, thus reducing the calculation amount of the feature similarity of the nodes (that is, the calculation amount of the attention scores of the central node and some neighborhood nodes is omitted), and improving training efficiency of the model. On the other hand, as the calculation amount of the feature similarity of the nodes can be accurately controlled to be relatively small in the model training stage, for a situation that the classification model training and prediction of node category are completed at the same time, that is, the second node can include a node to be classified, the category prediction efficiency of the node to be classified can still be ensured. Moreover, as the model parameter used in the category prediction is obtained through iteratively updating a parameter by taking the node to be classified as an unlabeled node, the accuracy of the model parameter is improved, and the effect of considering both category prediction efficiency and prediction accuracy can be achieved.

It should be noted that the embodiment of the storage medium in the present application is based on the same inventive concept as the embodiment of the data processing method in the present application, so the specific implementation of this embodiment can be referred to the implementation of the corresponding data processing method mentioned above, and is not repeated here.

Specific embodiment of that present application have been described above. Other embodiments are within the scope of the appended claims. In some cases, the actions or steps recited in the claims may be performed in a different order than in the embodiments and still achieve the desired results. In addition, the processes depicted in the drawings do not necessarily require the specific order or the sequential order shown to achieve the desired results. In some embodiments, multitasking and parallel processing are also possible or may be advantageous. It should be understood by those skilled in the art that embodiments of the present application can be provided as a method, a system or a computer program product. Therefore, embodiments of the present application may take the form of an entirely hardware embodiment, an entirely software embodiment, or an embodiment combining software and hardware aspects. Moreover, the present application can take the form of a computer program product implemented on one or more computer-readable storage medium (including but not limited to a disk storage, a CD-ROM, an optical storage, etc.) containing computer usable program codes.

The present application is described with reference to flowcharts and/or block diagrams of methods, devices (systems), and computer program products according to embodiments of the present application. It should be understood that each flow and/or block in the flowchart and/or block diagram, and combinations of the flow and/or block in the flowchart and/or block diagram can be implemented by computer program instructions. These computer program instructions may be provided to a processor of a general-purpose computer, special-purpose computer, embedded processor or other programmable data processing apparatus to produce a machine, such that the instructions which are executed by the processor of the computer or other programmable data processing apparatus produce means for implementing the functions specified in flow(s) of the flowchart and/or block(s) of the block diagram.

These computer program instructions may also be stored in a computer-readable memory that can direct a computer or other programmable data processing apparatus to function in a particular manner, such that the instructions stored in the computer-readable memory produce an article of manufacture including instruction means that implement the functions specified in flow(s) of the flowchart and/or block(s) of the block diagram.

These computer program instructions may also be loaded onto a computer or other programmable data processing apparatus, such that a series of operational steps are performed on the computer or other programmable apparatus to produce a computer-implemented process, such that the instructions executed on the computer or other programmable apparatus provide steps for implementing the functions specified in flow(s) of the flowchart and/or block(s) of the block diagram.

In a typical configuration, a computing device includes one or more processors (CPU), input/output interfaces, network interfaces, and memory. Memory may include non-permanent memory, random access memory (RAM) and/or nonvolatile memory of computer-readable medium, such as read-only memory (ROM) or flash memory. Memory is an example of a computer-readable medium. Computer-readable media, including permanent and non-permanent, removable and non-removable media, can store information by any method or technology. Information can be computer-readable instructions, data structures, modules of programs or other data. Examples of storage media for computers include, but not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassettes, magnetic disk storage or other magnetic storage devices or any other non-transmission media can be used to store information that can be accessed by computing devices. According to the definition in this paper, computer-readable media does not include temporary computer-readable media (transitory media), such as modulated data signals and carrier waves.

It should also be noted that the terms “including”, “comprising” or any other variation thereof are intended to cover non-exclusive inclusion, so that a process, method, commodity or device including a series of elements includes not only those elements, but also other elements not explicitly listed, or elements inherent to such process, method, commodity or device. Without more restrictions, an element defined by the phrase “including one” does not exclude the existence of other identical elements in the process, method, commodity or device including the element.

Embodiments of that present application may be described in the general context of computer-executable instruction, such as program modules, being executed by a compute. Generally, program modules include routines, programs, objects, components, data structures, etc. that perform particular tasks or implement particular abstract data types. One or more embodiments of the present application may also be practiced in distributed computing environments where tasks are performed by remote processing devices that are connected through a communication network. In a distributed computing environment, program modules may be located in local and remote computer storage medium including storage devices.

Each embodiment in the present application is described in a progressive way, and the same and similar parts between the embodiments can be referred to each other, and each embodiment focuses on the differences from other embodiments. Especially, for the system embodiment, because it is basically similar to the method embodiment, the description is relatively simple, and the relevant content can be found in part of the description of the method embodiment. The above is only an example of this document, and it is not used to limit this document. Various modifications and variations will occur to those skilled in the art. Any modification, equivalent substitution, improvement, etc. made within the spirit and principle of this document shall be included in the scope of the claims of this document.

What is claimed is:

1. A data processing method, the method comprises:
determining node information of a first node based on edge data and feature information of a second node of graph data; wherein the second node comprises a labeled node and the first node;
calculating feature similarity between the second node and a neighborhood node of the second node based on the node information of the first node; aggregating feature information of the second node based on the feature similarity and feature information of the neighborhood node;
determining a prediction result based on the aggregated feature information, wherein the prediction result comprises a predicted category label of the labeled node; and
iteratively updating a parameter of a classification model based on the predicted category label of the labeled node and a real category label of the labeled node.

2. The method according to claim 1, wherein the determining the node information of the first node based on the edge data and the feature information of the second node of the graph data comprises:
determining a first score of the second node based on the edge data between the second node and the neighborhood node of the second node;
determining feature information of a third node based on the first score and the feature information of the second node; wherein the third node is selected from the second node;
determining a second score of the third node based on the feature information of the third node; and
determining the node information of the first node based on the second score.

3. The method according to claim 2, wherein the determining the first score of the second node based on the edge data between the second node and the neighborhood node of the second node comprises:
determining a first matrix based on an adjacency matrix of the graph data and a first reference matrix of the graph data; wherein the adjacency matrix is obtained based on the edge data, the first reference matrix of the graph data is a column matrix comprising a plurality of preset values; and
determining the first score of the second node based on the first matrix.

4. The method according to claim 2, wherein the determining the feature information of the third node based on the first score and the feature information of the second node comprises:
determining a fifth matrix based on an initial matrix of the graph data and the third node; wherein the initial matrix is obtained based on the feature information of the second node, and the fifth matrix is a matrix comprising the feature information of the third node; and
determining the feature information of the third node based on the fifth matrix.

5. The method according to claim 4, wherein the determining the second score of the third node based on the feature information of the third node comprises:
determining a second matrix based on the fifth matrix, wherein the second matrix is a column matrix comprising the second scoreof the third node.

6. The method according to claim 5, wherein the determining the second score of the third node based on the feature information of the third node further comprises:
determining an eighth matrix based on the second matrix, wherein the eighth matrix is a column matrix comprising a difference between the second score of the third node and an average score;
determining a third matrix based on the second matrix and a second reference matrix, wherein the second reference matrix is determined based on the eighth matrix; and
determining the secondscore of the third node based on the third matrix.

7. The method according to claim 2, wherein the determining the node information of the first node based on the second score comprises:
determining a sixth matrix based on the first node; wherein the sixth matrix comprises any one of a seventh matrix and a fourth matrix, the seventh matrix is a matrix comprising feature information of the first node, and the fourth matrix is a matrix comprising a second score of the first node; and
determining the node information of the first node based on the sixth matrix.

8. The method according to claim 1, wherein the second node further comprises an unlabeled node, and the unlabeled node comprises a node to be classified, and the prediction result further comprises a predicted category label of the unlabeled node; wherein the method further comprises:
determining a predicted category label of the node to be classified based on the prediction result output by a last round of training of the classification model.

9. The method according to claim 1, further comprising:
acquiring the graph data corresponding to a classification task; wherein, in a condition that the classification task is a task for classifying articles, graph data of the task for classifying articles is acquired, wherein the second node comprises an article node;
in a condition that the classification task is a task for classifying risky users, graph data of the task for classifying risky users is acquired, wherein the second node comprises a user node; and
in a condition that the classification task is a task for classifying pushed users, graph data of the task for classifying pushed users is acquired, wherein the second node comprises the user node.

10. The method according to claim 9, wherein the feature information of the second node comprises feature information of an article or a user, and the edge data between the second nodes comprises a connection edge between two second nodes, and the connection edge indicates that there is a preset association relationship between two articles or between two users.

11. A category identification method, the method comprises:
determining node information of a first node based on graph data, wherein the graph data comprises a node to be classified and a sampled node, and the node to be classified and the sampled node comprise the first node;
calculating feature similarity between the node to be classified and a neighborhood node of the node to be classified based on the node information of the first node, aggregating feature information of the node to be classified based on the feature similarity and feature information of the neighborhood node; and
determining predicted category information of the node to be classified based on the aggregated feature information.

12. The method according to claim 11, further comprising:
acquiring the graph data corresponding to a classification task; wherein, in a condition that the classification task is a task for classifying articles, graph data of the task for classifying articles is acquired, wherein both the node to be classified and the sampled node comprise an article node;
in a condition that the classification task is a task for classifying risky users, graph data of the task for classifying risky users is acquired, wherein both the node to be classified and the sampled node comprises a user node; and
in a condition that the classification task is a task for classifying pushed users, graph data of the task for classifying pushed users is acquired, wherein both the node to be classified and the sampled node comprises the user node.

13. A computer device, comprising:
a processor; and
a memory arranged to store computer-executable instructions, the processor, when executing the computer-executable instructions, is configured to:
determine node information of a first node based on edge data and feature information of a second node of graph data; wherein the second node comprises a labeled node and the first node;
calculate feature similarity between the second node and a neighborhood node of the second node based on the node information of the first node; aggregate feature information of the second node based on the feature similarity and feature information of the neighborhood node;
determine a prediction result based on the aggregated feature information, wherein the prediction result comprises a predicted category label of the labeled node; and
iteratively update a parameter of a classification model based on the predicted category label of the labeled node and a real category label of the labeled node.

14. The computer device according to claim 13, wherein the processor is configured to:
determine a first score of the second node based on the edge data between the second node and the neighborhood node of the second node;
determine feature information of a third node based on the first score and the feature information of the second node; wherein the third node is selected from the second node;
determine a second score of the third node based on the feature information of the third node; and
determine the node information of the first node based on the second score.

15. The computer device according to claim 14, wherein the processor is configured to:
determine a first matrix based on an adjacency matrix of the graph data and a first reference matrix of the graph data; wherein the adjacency matrix is obtained based on the edge data, the first reference matrix of the graph data is a column matrix comprising a plurality of preset values; and
determine the first score of the second node based on the first matrix.

16. The computer device according to claim 14, wherein the processor is configured to:
determine a fifth matrix based on an initial matrix of the graph data and the third node; wherein the initial matrix is obtained based on the feature information of the second node, and the fifth matrix is a matrix comprising the feature information of the third node; and
determine the feature information of the third node based on the fifth matrix.

17. The computer device according to claim 16, wherein the processor is configured to:
determine a second matrix based on the fifth matrix, wherein the second matrix is a column matrix comprising the second scoreof the third node.

18. The computer device according to claim 17, wherein the processor is configured to:
determine an eighth matrix based on the second matrix, wherein the eighth matrix is a column matrix comprising a difference between the second score of the third node and an average score;
determine a third matrix based on the second matrix and a second reference matrix, wherein the second reference matrix is determined based on the eighth matrix; and
determine the secondscore of the third node based on the third matrix.

19. The computer device according to claim 14, wherein the processor is configured to:
determine a sixth matrix based on the first node; wherein the sixth matrix comprises any one of a seventh matrix and a fourth matrix, the seventh matrix is a matrix comprising feature information of the first node, and the fourth matrix is a matrix comprising a second score of the first node; and
determine the node information of the first node based on the sixth matrix.

20. A computer device, comprising:
a processor; and
a memory arranged to store computer-executable instructions, the processor, when executing the computer-executable instructions, is configured to perform the method according to claim 11.
